(19) United States
(12) Patent Application Publication
(10) Pub. No.: US 2011/0291972 A1
(43) Pub. Date: Dec. 1, 2011

(54) Serial Presentation With Interactive Guide

(75) Inventors: Robert David Berry, Philadelphia, PA (US); Michael James Barsanti, Philadelphia, PA (US); Joshua Eli Levitas, Philadelphia, PA (US); Chad Anthony Rutkowski, Collingswood, NJ (US)

(73) Assignee: THROWAWAY HORSE LLC, Philadelphia, PA (US)

(21) Appl. No.: 13/117,546

(22) Filed: May 27, 2011

Related U.S. Application Data
(60) Provisional application No. 61/349,304, filed on May 28, 2010.

(51) Int. Cl. G06F 3/041

(52) U.S. Cl. 345/173

(57) ABSTRACT

A device for presenting serial adaptation of a body of text, such as a work of literature for example, and a corresponding interactive reader's guide may provide an accessible platform for readers to experience a serial adaptation of a body of text. A first page of a first plurality of pages may be displayed. The first plurality of pages may be ordered and serially linked. Each of the first plurality of pages may display a frame of the serial adaptation of the body of text. Each page in a second plurality of pages may correspond to a respective page in the first plurality of pages. Each respective page in the second plurality of pages may display respective first guide information related to the respective frame of the respective page in the first plurality of pages to which the respective page in the second plurality of pages is linked.

### CROSS REFERENCE TO RELATED APPLICATIONS

This application claims the benefit of U.S. Provisional Application Ser. No. 61/349,304 filed May 28, 2010, the contents of which are hereby incorporated by reference in their entirety.

### BACKGROUND

Part of what imparts greatness to literary masterworks, such as novels, plays, myth cycles and lyric and epic poetry (“works of literature”) are the historical and cultural references that ground the works in a particular time and place. These references allow the reader to experience more directly new points of view and compare the experiences of other human beings separated by time and distance with their own. Many of these works also allude to passages in other, earlier literary masterworks, creating a kind of network of references that further demonstrate the interconnectedness of the human condition. Unfortunately, the sheer volume of referential material that gives these works their strength can also serve to confuse and alienate the modern reader.

To address this confusion there has long existed reader's guides of various kinds that serve to identify and explain the cultural, historical, and literary references and allusions that appear in literary works. These consist of two basic types—an annotated version of the work itself, and a separate book that is meant to be read as a companion piece to the work itself, either coincident with or shortly after reading the work. In the annotated version, footnotes are placed within the text of the work itself with explanation of the references appearing at the bottom of the page. In the companion guide the action of the work is summarized and the cultural, historical, and literary references and allusions identified and explained.

These conventional reader's guides pose distinct problems, however. In the case of annotated reader's guides, the footnotes often intrude upon the text itself, interrupting the reader's concentration while reading. Moreover, as the artistry of a work often exists in the flow, cadence, and rhythm of a work, much of that artistic nuance is lost in an annotated version of a work. This problem is often exacerbated by the length of such annotations, which can often stretch into one or more full pages, requiring the reader to absorb the information provided in the lengthy footnote, apply it to what had just been read, and then “get back into” the storyline of the work.

In the case of the companion guide, the problems posed by the annotated reader's guides are often reversed. That is, while the companion guide does not intrude upon the text of the work, the reader can get lost in the midst of reading the work without the immediate explanation offered by a footnote correlated with a discrete reference that is confusing to the reader. Thus the reader is required to muddle through the text of the work itself, the reader must remember what the reader had trouble understanding, and then the reader must go to the separate companion guide in the hopes that it can clarify ex post facto the references the reader found challenging. By then, the significance of the reference is likely to be lost. Moreover, if the companion guide is being read coincident with the reading of the work, the same problem of having to “get back into” the action of the work is posed with the companion guide as is posed with the annotated guide.

Both kinds of guides suffer from a common defect in that the commentator, well-intentioned as he or she may be, directs what references get explained and what information gets provided. Thus, the reader may often find his or her time wasted by the fact that the commentator is explaining references that the reader may already have knowledge of, or that the reader finds to be insignificant to the overall context of the work. The reader is essentially trapped by the commentator's selection of which references to explain and the manner in which the commentator chooses to explain it. There may be gaps in the reader's knowledge that are not addressed by the author, and thus the reader is consigned to either accept his or her ignorance or purchase additional guides or other materials to pursue that knowledge deficiency independently. The amount of time and effort spent in identifying that gap in knowledge, identifying the additional material that would help remedy the knowledge deficiency, and then acquiring the additional material may dissuade the reader from curing the knowledge deficiency, or would, in any event, disrupt the learning process in a manner that may adversely impact comprehension.

These guides further suffer from the fact that they are static, i.e., that their content once written never changes. There is no opportunity within the guides to engage the author in a dialogue to either clarify or challenge a point being made. There is no opportunity within the guides to engage with other readers to determine whether they possess knowledge the reader is seeking, or whether their viewpoint enhances or deepens the reader's perception of the text. There is no opportunity within the guides themselves to learn more about related but tangential topics that may further enhance comprehension and appreciation of the text. There are only the books, and then silence.

### SUMMARY

The serial adaptation of a body of text, such as a work of literature, or other expressions of information for example, and a corresponding interactive reader's guide disclosed herein provides an accessible platform for readers to experience a serial adaptation of a body of text as well as to gain the benefit of an interactive reader's guide.

A first page of a first plurality of pages may be displayed. The first plurality of pages may be ordered and serially linked. Each of the first plurality of pages may display a frame of the serial adaptation of the body of text.

An indication for content associated with a second page of a second plurality of pages may be received. Each page in the second plurality of pages may correspond to a respective page in the first plurality of pages. Each respective page in the second plurality of pages may display respective first guide information related to the respective frame of the respective page in the first plurality of pages to which the respective page in the second plurality of pages is linked.

The second page may be displayed in response to the indication.

### BRIEF DESCRIPTION OF THE DRAWINGS

FIG. 1 illustrates a networked system for delivering a serial adaptation of a body of text and a corresponding interactive reader's guide.

FIG. 2 depicts an example architecture for delivering a serial adaptation of a body of text and a corresponding interactive reader's guide.

FIG. 3 depicts an example software architecture and corresponding algorithms for delivering a serial adaptation of a body of text and a corresponding interactive reader's guide.

FIG. 4 illustrates an example tablet device interface for a serial adaptation of a body of text and a corresponding interactive reader's guide.

FIGS. 5A&B illustrate example tablet device interfaces displaying a corresponding readers guide page.

FIG. 6 illustrates an example tablet device interface displaying a networked guide page.

FIG. 7 depicts an e-book application structure within which a serial adaptation of a body of text and a corresponding interactive reader's guide may be delivered.

FIG. 8A illustrates an example process flow for a website-based delivery of a serial adaptation of a body of text and a corresponding interactive reader's guide.

FIG. 8B illustrates an example process flow for an application software-based delivery of a serial adaptation of a body of text and a corresponding interactive reader's guide.

### DETAILED DESCRIPTION

A serial adaptation of a body of text, such as a work of literature, and a corresponding reader's guide may be provided. A serial adaptation of a body of text and a corresponding reader's guide may be implemented by a computing device, such as a computer, tablet device, smart phone, and/or stored on a computer-readable storage medium.

In an embodiment, the body of text may be adapted to a serial format. For example, each page of a serial adaptation of the work may capture, represent, and/or summarize an event or moment in the narrative of the work. A page of the serial adaptation may include one or more graphical images (such as one or more panels) illustrating an aspect of the event or moment in the narrative of the work.

Each page of the serial adaptation may be associated with a corresponding reader's guide page. The corresponding reader's guide page may provide explanation and discussion of the event and/or moment depicted and/or summarized in the serial adaptation of the work. For example, the corresponding reader's guide page may have a didactic explanation of what was depicted or summarized in the serial adaptation of the page, links to resources available over the Internet or some other networked source, a discussion page in which the page of the serial adaptation is discussed, and/or a combination thereof.

This combination provides greater flexibility than traditional sources. To illustrate, a reader, following along with the narrative of the work as depicted and/or summarized in the serial adaptation, may progress without interruption through the narrative without disrupting the flow of the work. If the reader is confused about what is occurring in the book (as depicted by the serial adaptation pages), the reader may access the reader's guide page that corresponds with the specific serial page of the adaptation causing the reader problems. For example, the reader can escape the forced interruption of narrative flow caused by the intrusion of footnotes or the need to open a second book but still have ready access to additional information. The system and methods disclosed herein may reduce the need for a reader to resort to a separate reference work. The system and methods disclosed herein may provide access to the reader's guide directly from the adaptation pages and also provide an interface to quickly return to the place in the narrative where the reader left off. To the extent the reader's attention has been interrupted, the adaptation can assist the reader in reengaging with the narrative flow of the work, facilitating greater enjoyment and comprehension of the work. The relative speed with which the reader can reengage with the narrative or content of the work is made possible by the use of a the architecture and structures and interfaces disclosed herein.

In an embodiment, the serial adaptation may include one or more panels of a graphic novel and/or comic book. For example, the panels may be presented via a plurality of pages. The pages may be each serially linked to the next page. On each page one or more images may be displayed. For example, the images may be accompanied by text relating to the adapted literary work. For example, the images generally depict the action of the work. The action of the work may be internal or external. The action may be characters interacting with each other, the characters being subject to natural or man-made phenomena or events, or the characters reflecting internally on said interaction, phenomena, or events. To illustrate, the images may depict establishing shots depicting the place and time in which the action is taking place, depict historical or cultural artifacts otherwise unfamiliar to the reader, and/or generally correspond to, or otherwise explicate, the narrative of the work. The serial adaptation may include serial animation, dramatic enactment enabled by video, oral recitations of the work. The serial adaptation may be comprised of a combination of images, animation, dramatic enactment enabled by video, and/or oral recitations of the work.

A second plurality of pages may each be linked to a respective one of the first plurality of pages. For example, each page of first plurality of pages may be associated with a corresponding page in the second plurality of pages. Any given page of the second plurality of pages may comment, present didactic explanation of what was depicted or summarized in the serial adaptation of the page, link to resources available over the internet or some other networked source, present a discussion page in which the page of the serial adaptation is discussed, and/or some combination thereof.

The reader may read the material on the corresponding guide page, find the desired information, and return rapidly to the adaptation on the first plurality of pages. The reader may leave a comment, follow a link, and/or use resources on the reader's guide page to continue further learning, including accessing the internet through links that may be provided on the page. In an embodiment, the second plurality of pages may themselves be serially linked, such that reader may progress through the reader's guide.

The serial structure of the first plurality of web pages and the corresponding one-to-one relationship with corresponding guide pages provides a technical function related to the cognitive pacing. The cognitive pacing as dictated by the structure of pages enables a content provider to tailor the content to specific segments of information. The user's ability to absorb and comprehend the information being relayed may be enhanced by having the content segmented into individually contained portions. These portions may each represent an idea or point that is suitable for separate explanation. Thus, by serially linking the pages and their corresponding guide pages, the structure disclosed herein may enhance the reader's comprehension. Moreover, this function of enabling cognitive pacing generally would not be present if the content were displayed as mere text on one continuous virtual page (such as text on a traditional webpage or traditional e-book). The pacing of these legacy pages are driven by the dictates of font size and page space. In contrast, the structure disclosed herein enables the content creator to adjust the content to correspond with a cognitive pacing of his/her choosing, tailoring it to the specific audience he/she is trying to reach.

The pages described above may be presented in a variety of ways. For example, the pages may be presented in the context of an internet website. The pages may be internet web pages, such as hypertext markup language (HTML) pages.

The pages may be screens presented in the context of an application on a computing device. For example, the pages may be presented as an “app” on a personal entertainment device such as a smart phone, tablet device, or the like. The application may support internet connectivity.

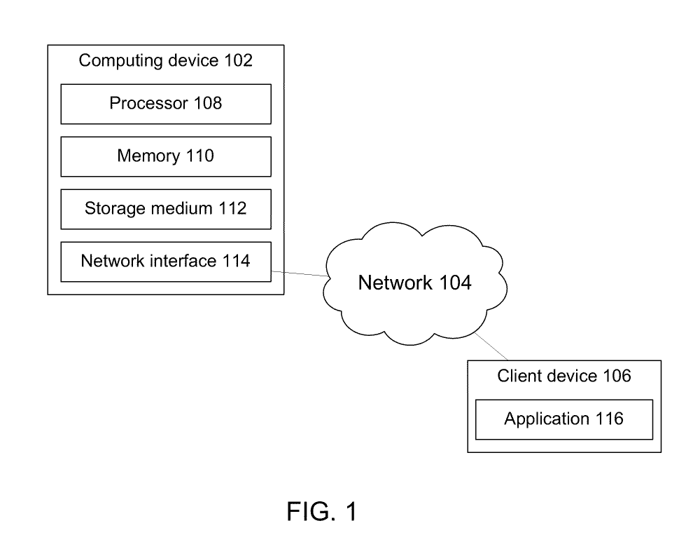

FIG. 1 illustrates a networked system for delivering a serial adaptation of a body of text and a corresponding interactive reader's guide. The networked system may include a computing device 102, a network 104, and a client device 106. The computing device 102 may be in communication with the network 104. The client device 106 may be in communication with the network 104. The computing device 102 and the client device 106 may be able to communicate with one another via the network 104.

The computing device 102 may be a device suitable for computing information and communicating. For example, the computing device 102 may be a computer, server computer, network appliance, virtual machine (with or without a host), or the like. The computing device 102 may be suitable for storing and delivering information, such as an application, internet pages, interactive content, and/or dynamic content. The computing device 102 may be suitable for receiving requests for information, such as requests for an application, internet pages, interactive content, and/or dynamic content. The computing device 102 may store static information, such as static pages. The computing device 102 may be suitable for constructing dynamic pages, such as through server-side scripting technology. The computing device 102 may include storage of the data from which dynamic pages may be constructed. For example, the computing device 102 may include an interface to a database having stored therein data from which dynamic pages may be constructed.

The computing device 102 may include a processor 108, a memory 110, a storage medium 112, and/or a network interface 114. The processor 108 may include any hardware, software, and/or combination thereof suitable for processing data. The processor 108 may be a microprocessor, an application specific integrated circuit (ASIC), a field gate array (FGA), an emulated and/or virtual processor, and/or the like.

The memory 110 may be any device suitable for storing data. For example, the memory 110 may include random access memory (RAM), read only memory (ROM), hard disk storage memory, swap memory, cache memory, register memory, and/or the like. The memory 110 may be volatile or nonvolatile. The memory 110 may load and/or store instructions that when executed by the processor 108 operate the computing device 102.

The storage medium 112 may include any device suitable for storing data and/or computer executable instructions. The storage medium 112 may be non-transitory, (i.e., nonvolatile) storage memory. The storage medium 112 for example may include a computer magnetic hard disk, optical desk, flash memory, or the like. The storage medium 112 may store data such as whole and/or component parts of pages, such as web pages for example, that may be requested from and served by the computing device 102. The storage medium 112 may store data associated with content of an interactive readers guide. The storage medium 112 may store computer executable instructions. The storage medium 112 may store computer executable instructions associated with receiving and delivering pages. The computer executable instructions when loaded into the memory 110 and executed by the processor 108 may operate the computing device 102 to receive requests, process them, and respond with corresponding pages. The storage medium 112 may include instructions for formulating dynamic pages and/or for providing interactive content, such as via common gateway interface, active server pages, flash programming, JAVA programming, and the like.

The network interface 114 may include any hardware, software, or combination thereof suitable for providing communications between computing device 102 and a network (such as that illustrated in FIG. 1 as network 104). The network interface may include an Ethernet interface, a Gigabit Ethernet interface, an FDDI interface, a Universal Serial Bus interface, a wireless networking interface, such as WiFi, WiMax, or the like.

The network 104 may include any combination of device or combination of devices suitable for transmitting and receiving communicating data. For example, the network 104 may include a local area network, a wide area network, a metropolitan area network, a wireless local area network, a wireless cellular network, or the Internet, and/or the like. The network 104 may include a combination of interconnected networking technologies. To illustrate, the network 104 may include a Gigabit Ethernet Interface from an access router (not shown) to the computing device 102. The access router may be connected to one of a number of interconnected core routers (not shown) by an optical carrier interface. One of the interconnected core routers my be connected to an access network, such as a hybrid fiber coax network, a fiber to the home network, another access router, or the like. The access network may provide connectivity to the client device 106.

The client device 106 may include any device suitable for processing and displaying pages, such as internet pages, application pages, e-book pages, and the like. The client device 106 may include a human interface, such as a keyboard, mouse, touch screen, voice recognition, remote control, physical buttons, etc., to enable interactive features. For example, the client device 106 may include a personal computer, such as a desktop computer, laptop computer, netbook computer, etc., a handheld computer, a smart phone, a touch screen device, such as a touch screen tablet device and/or a touch screen smart phone, a web-enabled device, such as a web-enabled television, and/or the like. The client device 106 may include one or more devices acting in cooperation. For example, the client device 106 may include a computer and a universal serial bus connected tablet device acting in cooperation. To illustrate, the computer may provide network connectivity to download and install an application onto the tablet device.

The client device 106 may include an application 116. The application 116 may include a set of instructions that when executed by a processor of the client device 106 operate the client device 106 to perform certain activities.

In an embodiment, the application 116 when executed may cause the client device 106 to be enabled to request and receive internet pages from the computing device 102 and the application 116 may provide interactive functionality to a user of the client device 102. For example, the application 116 may include a web browser. The application 102 may be programmed according to suitable algorithms, such as those that implement the hypertext transfer protocol (HTTP) for sending requests for and receiving internet pages.

In an embodiment, the application 116 may be an application software suitable for a touch screen device, such as a tablet computer and/or tablet device. For example, the application 116 may be an app suitable for the Apple™ iPhone™ and/or iPad™. For example, the application 116 may be suitable for the iPhone™ and/or iPad™ operating system, such as iPhone OS 3.2 and iPhone OS 4. One will appreciate that the application 116 may be implemented for any OS (e.g., the Android OS) and/or any version. The application 116 may be a package for download from the computing device 102. For example, the computing device 102 may implement an application store, from which the application 116 may be downloaded.

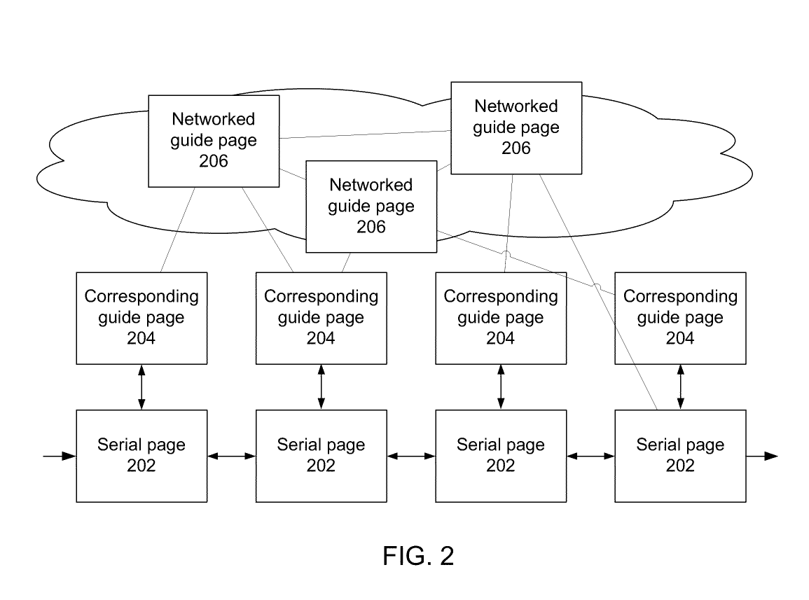

FIG. 2 depicts an example architecture for delivering a serial adaptation of a body of text and a corresponding interactive reader's guide. The presented architecture may be delivered as a web-based service and/or a local application. The architecture may include a plurality of serial pages 202, a plurality of corresponding guide pages 204, and a plurality of networked guide pages 206, and/or the like.

The serial adaptation of the body of text may be presented as individual frames, each on one of the plurality of serial pages 202. The serial pages 202 may be ordered. For example, the serial adaptation of the body of text may have a forward and backward flow direction that corresponds to the ordered nature of the serial pages 202. For example, the serial pages 202 may be ordered numerically with one number associated for each frame of the serial adaptation of the body of text. Each frame of the serial adaptation of the body of text may include subframes that are displayed therein. Typically, a frame may occupy one screen-full of information. The frame may include an illustrative depiction of a portion of the body of text. The frame may include vibrant colors and illustrations to make the body of text accessible. The frame may include snippets of text and/or dialogue. For example, dialogue may be enclosed in callout bubbles. The text and dialogue may correspond to a certain portion of the serial adaptation of the body of text.

By viewing the serial ordered pages in either the forward or backward flow direction a user may appreciate the body of text without having to encounter the difficulties associated with a direct reading of the text of the body of text. The simplified structure of the serial pages may facilitate maintaining a reader's attention. For example, young school-aged users may find the serial order presentation of the frames to be without the distraction associated with other delivery technologies, such as internet and television delivery.

Each of the serial pages 202 may have a link to a corresponding guide page 204. The corresponding guide page 204 may have a one-to-one correspondence to the serial pages 202. Each corresponding guide page 204 may include content that is associated with frame displayed by the corresponding serial page 202.

To illustrate, an ordered, serial page 202 may be labeled “0005” and may include a frame. The user may be able to link from the serial page 202 to the corresponding guide page 204. At the corresponding guide page 204 may be content describing the importance, relevance, background, interesting details, perspective, context, and the like of the frame of the serial page 202 labeled “0005” within the body of text.

The corresponding guide pages 204 may also be linked in a serial fashion in addition to being linked to their corresponding serial pages. For example, a user may be able to use the interactive readers guide by moving in a forward or backward flow direction through the guide pages 204.

One or more of the corresponding guide pages 204 may be linked to networked guide pages 206. The networked guide pages 206 may include content that is associated with a concept, such as a character, place, object, relevant point, or other concept, that may appear in one or more serial pages 202, one or more corresponding guide pages 204, and/or one or more other networked guide pages 206. Networked guide pages 206 may be linked to one or more serial pages 202, one or more corresponding guide pages 204, and/or one or more other networked guide pages 206, as appropriate.

To illustrate, information about a particular character in the body of text may appear on a networked guide page 206 when that character appears in multiple serial pages 202 and/or multiple corresponding guide pages 204. Similarly, a place, object, relevant point, or other concept may be associated with a networked guide page 206. Because the character, place, object, relevant point, or other concept may occur in one or more corresponding guide pages 204, one or more serial pages 202, and/or one or more other networked guide pages 206, the networked guide page 206 associated with that character, place, object, relevant point, or other concept may be linked to each occurrence of that character, place, object, relevant point, or other concept within the one or more corresponding guide pages 204, one or more serial pages 202, and/or one or more other networked guide pages 206.

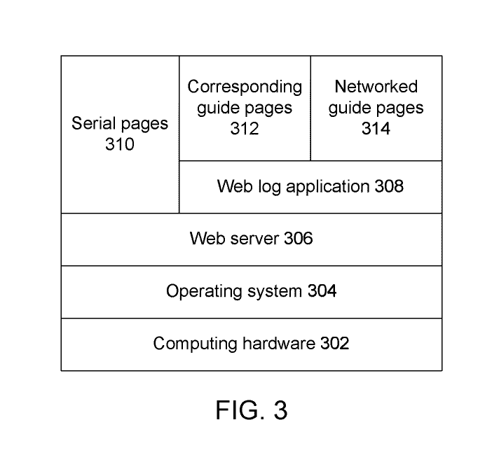

FIG. 3 depicts an example software architecture and corresponding algorithms for delivering a serial adaptation of a body of text and a corresponding interactive reader's guide. The software architecture may include computing hardware 302, an operating system 304, a web server 306, a web log application 308, and data such as serial pages 310, corresponding guide pages 312, and/or networked guide pages 314.

In an embodiment, the web server 306 may include application software to receive and process HTTP requests and delivers pages. The web server 306 may run in a operating system 304, such as UNIX™, Linux, Microsoft Windows™, and the like. The operating system 304 may be installed on a computing platform. The computing platform may be a native or virtual environment running on computer hardware 302, such as the computing device 102 illustrated in FIG. 1.

The web server 306 may directly serve serial pages 310. The serial pages may be relatively static pages and suitable for delivery by the web server 306. The ordered and serially linked aspect of the serial pages 310 may be encoded in hypertext markup language (HTML) of the individual serial pages 310 themselves. Similarly, the serial pages 310 may have encoded in the HTML therein links to respective, corresponding guide pages 312. The serial pages 310 may be dynamically constructed by application software (such as a server-side application and/or script) operating in cooperation with the web server 306.

The web log application 308 may be referred to as a blog application. The web log application 308 may, in cooperation with the web server 306, provide the corresponding guide pages 312 and/or the networked guide pages 314. The corresponding guide pages 312 and/or the networked guide pages 314 may be considered individual posts within the web log application 308. For example, the web log application 308 may be the Wordpress™ web log application. The corresponding guide pages 312 and/or the networked guide pages 314 may contain links.

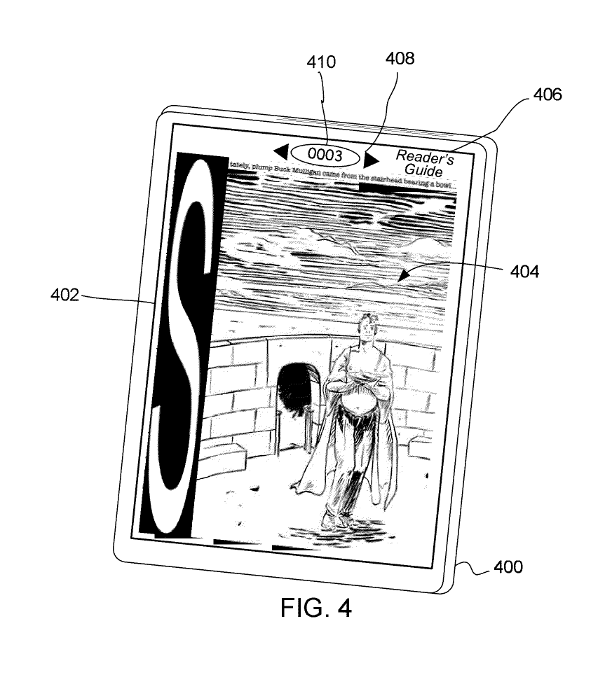

FIG. 4 illustrates an example interface for a tablet device 400. The interface may support a serial adaptation of a body of text and a corresponding interactive reader's guide. The tablet device 400 may display a serial page 402. The serial page 402 may include a panel 404, a link 406 to a corresponding guide page, a navigation control 408, and/or a placement indicator 410.

The panel 404, as illustrated, may contain a graphic image depicting an event within the body of text. The panel 404, also as illustrated, may contain text associated with the event.

The page 402 may be serial linked in a forward flow direction and a backward flow direction. For example, the interface may include operable navigation control 408 to direct the user to either the next page in the serial pages or the previous page in the serial pages. For example, as illustrated, a right arrow may move the interface to the next serial page. A left arrow may move the interface to a previous serial page. The serial pages, being ordered, may include a placement indicator 410, such as reference number, timeline, or other textual or graphical indication of the displayed page's relative position among the other serial pages.

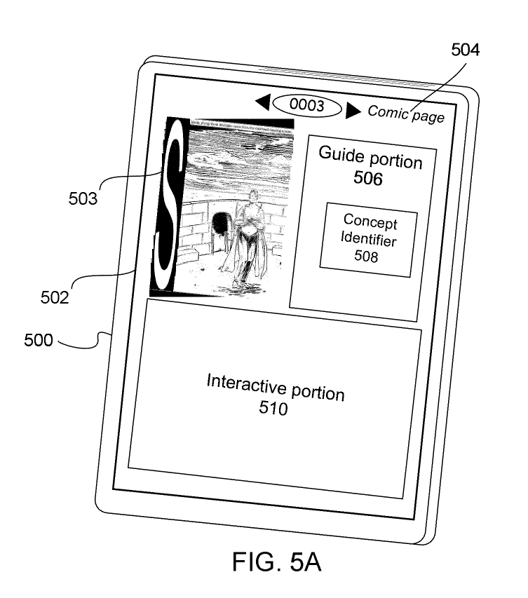

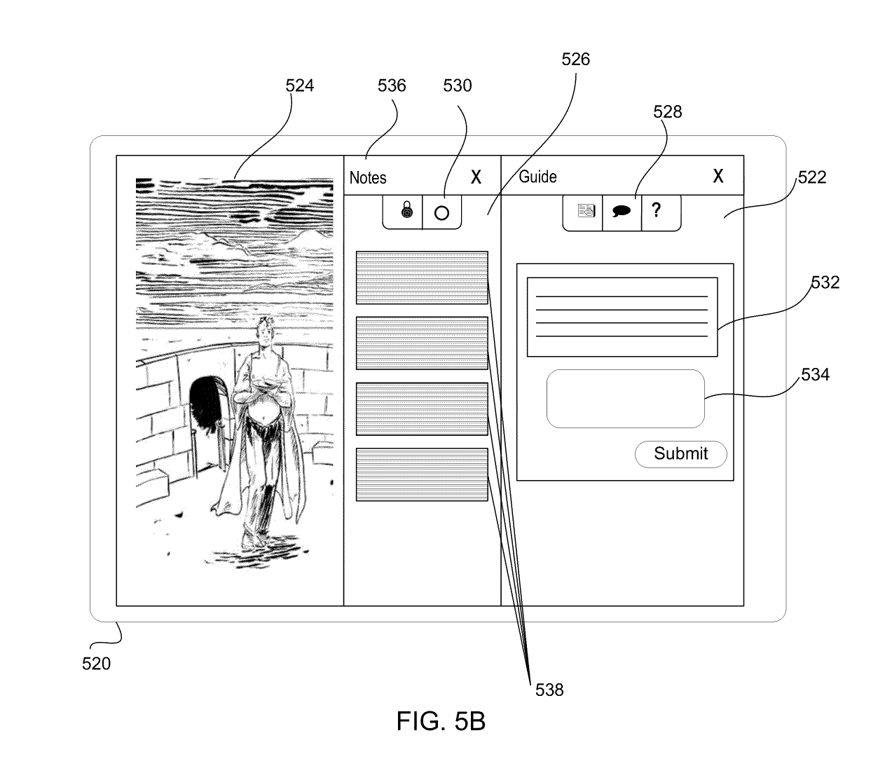

The interface may include a link 406 to a corresponding guide page. Clicking the link 406 may cause the interface to navigate the user from the serial page 402 to a corresponding guide page, such at the guide page 502 as illustrated in FIG. 5A, for example. Given the clarity of design, the serial page 402 may provide a reader an additional level of accessibility to the body of text and may minimize distractions associated with other media.

FIG. 5A illustrates an example interface for a tablet device 500 for displaying a corresponding readers guide page 502. The guide page 502 may contain a thumbnail 503, such as a smaller version of the panel, such as the panel 404 illustrated in FIG. 4. When transitioning from the serial page 402 (shown in FIG. 4) and the guide page 502 (shown in FIG. 5), the application may provide an animated transition of the panel 404 to the thumbnail 503 (shown in FIG. 5). The animated transition may include visual and/or audio feature such as zooming, changing color depth, “swooshing” sound effects and the like. The guide page 502 may include a link 504 to the corresponding serial page. The guide page 502 may include a guide portion 506, that may include one or more concept identifiers 508, and/or an interactive portion 510.

The guide portion 506 may contain descriptive text providing background, commentary, context, and the like for the event or activity depicted in the corresponding serial page's panel. For example, the guide portion 506 may describe the relevance and/or importance of the activity being depicted in the panel. The guide portion 506 may contain additional images, video, audio clips, or other multimedia to help describe the activity being depicted by the serial page. The guide portion 506 may include one or more concept identifiers 508.

The concept identifiers 508 may be any object within the guide portion 506 that identifies a concept. The concept identifier 508 may include a word, picture, audio file, or other multimedia, and the like. The concept identifier 508 may be associated with a concept that occurs in the context of multiple serial pages and/or multiple guide pages. The concept identifier 508 may provide a functional link to a networked guide page. The target network guide page may not be associated with any one particular panel and may be networked in such a way to be associated with one or more panels by way of the guide portion of the respective guide pages. For example, the concept identifier 508 may identify a particular character, place, event, object, and the like that is present throughout the literature and provides some relevance in the guide portions of the respective guide pages.

The guide page 502 may also include an interactive portion 510 that provides user interactivity related to the subject matter of the guide portion 506 and the corresponding panel. For example, the interactive portion 510 may provide a question-and-answer stream, a text chat, a voice over IP teleconference link, a modifiable frequently asked questions list, a comment-posting enabled message board, a short message service broadcast function, a social networking application, a computer game, and the like. The interactive portion 510 may provide users the opportunity to interact with other users and/or one or more super users. The super users may be users responsible for authoring certain panels and/or guide portions of guide pages and/or network guide pages.

FIG. 5B illustrates an example interface for a tablet device 520 for displaying a corresponding readers guide page. The guide page may contain a guide portion 522, an image 524, such as a smaller version of the panel, such as the panel 404 illustrated in FIG. 4, and/or a notes portion 526. The guide portion 522 may include a guide navigation bar 528. The notes portion 526 may include a notes tool bar 530.

The guide portion 522 may contain guide information such as descriptive text providing background, commentary, context, and the like for the event or activity depicted in the corresponding serial page's panel. For example, the guide portion 522 may describe the relevance and/or importance of the activity being depicted in the panel. The guide portion 522 may contain additional images, video, audio clips, or other multimedia to help describe the activity being depicted by the serial page. The guide portion 522 may include one or more concept identifiers (not shown).

The guide portion 522 may also include interactive elements such as the guide navigation bar 528. The guide navigation bar 528 may provide interactive features such as enabling users to switch, within the guide portion 522, from the body of the guide information to one or more interactive forms. The interactive forms may enables users to post comments to a discussion board associated with the guide page and/or to answer or post questions associated with the guide page. For example, the guide portion 522 may include a question 532 that engages the user with subject matter associated with the guide page. The guide portion 522 may include a text field 534 where a user may leave a response to the question 532. To illustrate, the tablet device 520 may be used in a learning environment, such as a school, in which students answer the questions posed on guide pages as part of the class.

The notes portion 526 may be hidden and/or expanded based on a touch of a notes icon 536. When expanded, the notes portion 526 may display one or more notes 538 taken by the user and stored at the tablet device or at a remote storage. The notes 538 may be associated with one or more pages of the serial adaptation. The notes 538 may be individually expandable to preserve screen space. The notes toolbar 530 may provide additional interactive features, such as enabling the user to set highlighted notes as either private notes or group notes. For example, privates notes would be available solely for the use of the tablet device's user. Group notes may be available and shared with a larger audience. For example, the larger audience may include a closed group, such as a book club, class, or on-line learning cohort. The larger audience may also include the general public.

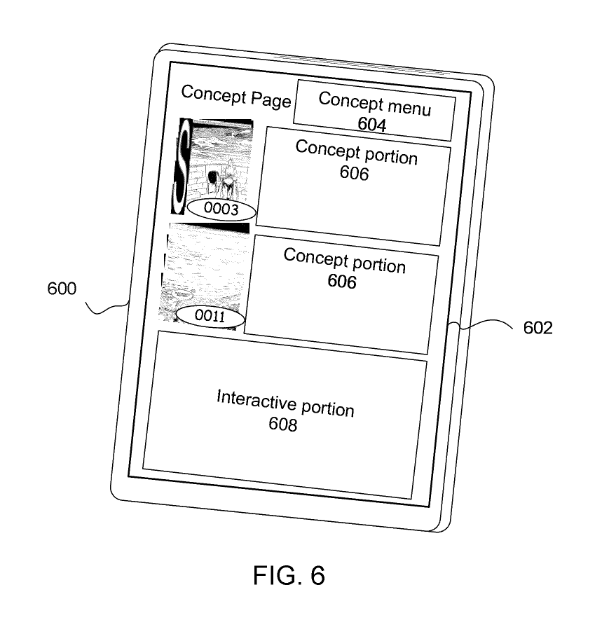

FIG. 6 illustrates an example interface of a tablet device 600 for displaying a networked guide page 602. The networked guide page 602 may correspond to a concept identifier, such as the concept identifier 508 illustrated in FIG. 5. For example, a user clicking or tapping the concept identifier 508 in FIG. 5 may be navigated to the networked guide page illustrated in FIG. 6.

The networked guide page 602 may include a concept menu 604, one or more concept portions 606, and/or one or more interactive portions 608. The networked guide page 602 may describe a concept as it is weaved throughout the body of text and the corresponding panels.

For example, as illustrated in FIG. 6, a concept may be present in panel number 0003 and panel number 0011. Thumbnails of the corresponding serial pages may be present and displayed to the user with corresponding text and/or multimedia describing the concept in more detail. The concept menu 604 may provide links to other networked guide pages. The concept portions 606 may also include one or more concept identifiers (not shown) to link to other network guide pages.

The networked guide page 602 may also include an interactive portion 608 that provides user interactivity related to the concept associated with the networked guide page 602. For example, the interactive portion 608 may provide a question-and-answer stream, a text chat, a voice over IP teleconference link, a modifiable frequently asked questions list, a comment-posting enabled message board, a short message service broadcast function, a social networking application, a computer game, and the like. The interactive portion 608 may provide users the opportunity to interact with other users and/or one or more super users. The super users may be users responsible for authoring certain panels and/or guide portions of guide pages and/or network guide pages.

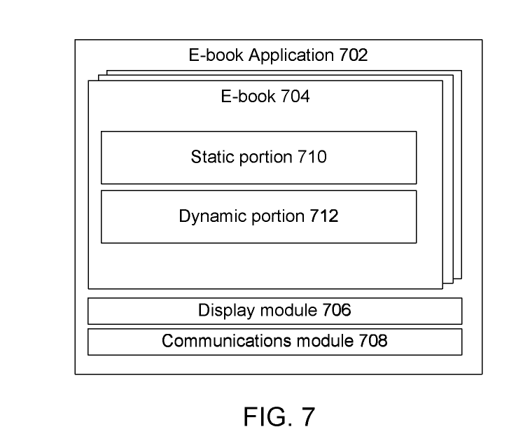

FIG. 7 depicts an e-book application 702 structure within which a serial adaptation of a body of text and a corresponding interactive reader's guide may be delivered. The e-book application 702 may be suitable for packaging and delivering the serial adaptation of a body of text and a corresponding interactive reader's guide as an iPhone™ and/or iPad™ app, as an application software package to a computer, or the like. The e-book application 702 may include an e-book portion 704, a display module 706, and/or a communications module 708.

The display module 706 may include data and computer instructions suitable for handling how the e-book portion 704 is displayed and how instructions from a user interface may be received.

The communications module 708 may include data and/or computer instructions to handle communications to a network. The communications module may provide instructions for requesting and fetching pages for example.

The e-book portion 704 of the e-book application 702 may include data and computer instructions suitable for displaying the serial adaptation of the body of text and/or the corresponding guide pages and/or the corresponding network pages. The e-book portion 704 may include a static portion 710 and a dynamic portion 712.

The static portion 710 may include aspects of the e-book associated with a long duration between changes. For example, the changes may include minor revisions, edits, updates, and the like. The nature of these changes are such that they have a relatively long duration of time between them. To illustrate, the individual serial frames of the serial adaptation of the body of text, menu icons, frame layouts, color schemes, navigation architecture, and the like may be part of the static portion 710 of the e-book portion 704.

The dynamic portion 712 of the e-book portion 704 may include data that is likely to change within a short timeframe. For example, the dynamic portion 712 may include guide pages, interactive comments from users, links to other sources of information, and/or the like. The dynamic portion 712 of the e-book portion 704 may include one or more pointers, that when handled by the communications module 708, fetch dynamic content. The dynamic portion 712 may be operable as a function of network access. For example, the dynamic portion 712 may, when a network is accessible, download or fetch dynamic content to be stored in a cache to be used and/or displayed at a later time. Also for example, the portion 712 may operate on the condition of network access, such that when a network is not available, the dynamic portion displays an error message or an icon indicating that network access is required.

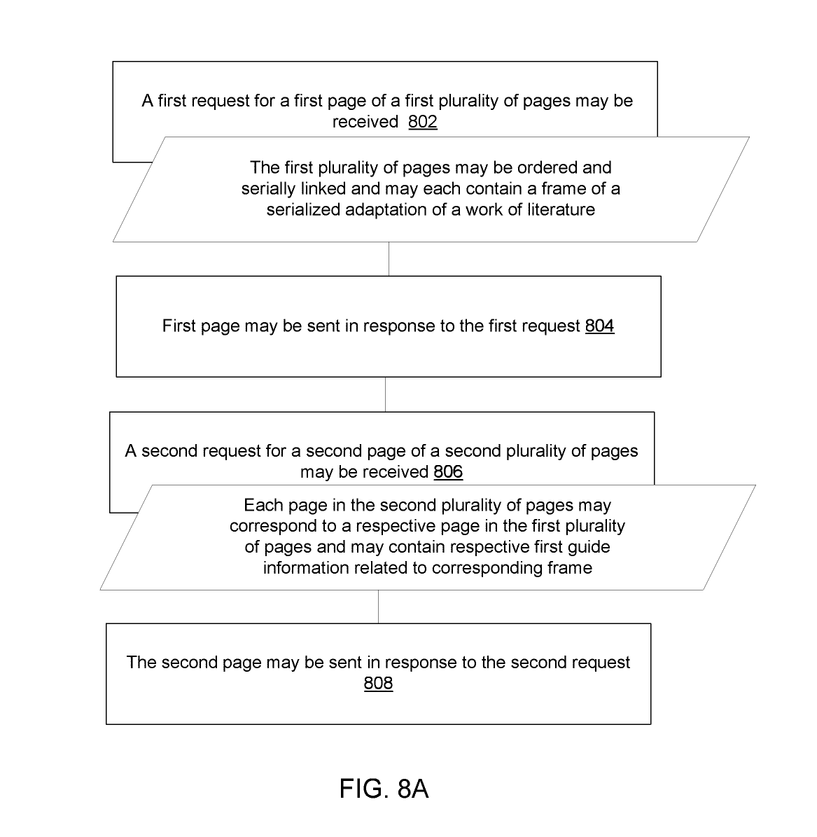

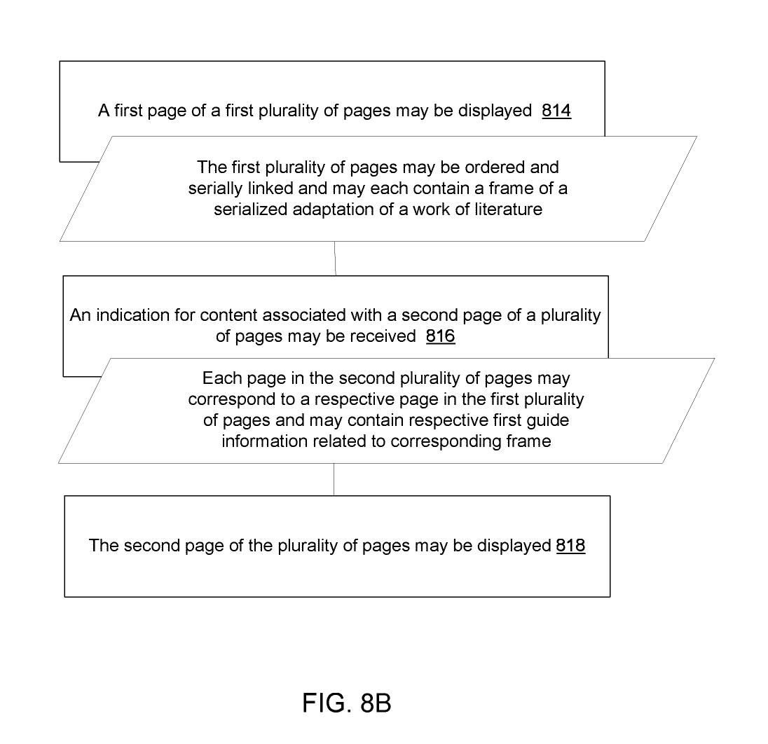

FIGS. 8A & 8B illustrate example process flows for delivering a serial adaptation of a body of text and a corresponding interactive reader's guide. For example, the process depicted in FIG. 8A may correspond to a website-based delivery of the serial adaptation of a body of text and a corresponding interactive reader's guide. For example, the process depicted in FIG. 8B may correspond to a application software-based delivery of the serial adaptation of a body of text and a corresponding interactive reader's guide.

With regard to FIG. 8A, at 802, a request for a first page of a first plurality of pages may be received. The first plurality of pages may be ordered and serially linked. Each page of the first plurality of pages may display a frame of the serial adaptation of the body of text.

At 804, the first page may be sent in response to the first request.

At 806, a second request for a second page of a second plurality of pages may be received. Each page in the second plurality of pages may correspond to a respective page in the first plurality of pages. Each respective page in the second plurality of pages may display respective first guide information related to the respective frame of the respective page in the first plurality of pages to which the respective page in the second plurality of pages is linked. The first guide information may include a plurality of concepts.

At 808, the second page may be sent in response to the second request. Comment information may be received via a communications channel, such as a web-based communications channel, in connection with the second web page. The comment information may be stored such that the comment information is made part of the second page.

Moreover, a third plurality of pages arranged in a network such that each page in the third plurality of pages is linked to at least one other page in the third plurality of pages may be stored. Each page in the third plurality of pages may be associated with a respective concept. At least one page of the third plurality of pages may be linked to at least one page of the second plurality of web pages.

Moreover, comment information may be received via a communications channel in connection with a third page of the third plurality of pages. The comment information may be stored such that the comment information is made part of the third page.

With regard to FIG. 8B, at 814, a first page of a first plurality of pages may be displayed. The first plurality of pages may be ordered and serially linked Each of the first plurality of pages may display a frame of the serial adaptation of the body of text.

At 816, an indication for content associated with a second page of a second plurality of pages may be received. For example, a user may indicate a desire to navigate from the first page to the second page. Each page in the second plurality of pages may correspond to a respective page in the first plurality of pages. Each respective page in the second plurality of pages may display respective first guide information related to the respective frame of the respective page in the first plurality of pages to which the respective page in the second plurality of pages is linked.

At 818, the second page may be displayed in response to the indication.

One will appreciate that the disclosure may be applied to other works apart from or in addition to adaptations of bodies of text, such as works of literature. The manner in which the embodiments aid comprehension may also be used for comic books and adaptations of technical information, including explanations of pharmaceutical products; explanations of scientific or industrial products; explanation of financial services products; teaching of scientific, technical, or abstract information for on-line and tablet-aided learning, including but not limited to the sciences, economics, philosophy and the like; and popular explanations of difficult and/or abstract concepts for the general reader.

Moreover, one will appreciate that the systems, devices, and methods disclosed herein enable a number of user interface features. For example, the device may enables users to pinch and zoom into the images allowing greater examination of detail of the drawing. The device may provide pop up translation of foreign words and phrases. The device may enable a selective grouping of further web links in the reader's guide for self directed learning. In some embodiments, the reader's guide and the serial adaptation may be present side-by-side. The device may enable the user to increase and/or decrease the size of the reader's guide text. The device may include a search field to specific pages of the adaptation with a visual table of contents. The device may enable the ability to skip ahead to later pages in the adaptation by swiping a page scale at the bottom of the page and the ability to open up a web browser in a pop up window of related linked web pages in the app without leaving the application.

The device may provide a number of learning features such as the ability to create password and other secure access servers for limiting access to features, the ability to leave a question for an instructor in a secure environment, the ability to create notes tied to specific pages of the adaptation, the ability to designate such notes as private or shared among a secure group, the ability to store the underlying source material being adapted, the ability to split the screen to allow viewing of the underlying source material being adapted, the ability to split the screen to allow for simultaneous viewing of the adaptation, source material, notes, and guide sections, and/or the ability to receive push notifications when comments are left responsive to earlier comments.

While the present invention has been described in connection with the disclosed embodiments, it is not limited thereto and it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims. Also, the appended claims should be construed to include other variants and embodiments of the invention, which may be made by those skilled in the art without departing from the true spirit and scope of the present invention.

What is claimed:

1. A touch screen tablet device for structuring data associated with a serial adaptation of a body of text and an accompanying interactive reader's guide, the device comprising:
a processor configured to:
enable the display a first page of a first plurality of pages, wherein the first plurality of pages are ordered and serially linked, wherein each of the first plurality of pages displays a frame of the serial adaptation of the body of text,
receive an indication for content associated with a second page of a second plurality of pages, wherein each page in the second plurality of pages corresponds to a respective page in the first plurality of pages, wherein each respective page in the second plurality of pages displays respective first guide information related to the respective frame of the respective page in the first plurality of pages to which the respective page in the second plurality of pages is linked, and
enable the display of the second page in response to the indication.

2. The device of claim 1, wherein the processor is further configured to receive comment information via the second page and to communicate the comment information via a communications channel to a server.

3. The device of claim 1, wherein the first guide information comprises a plurality of concepts.

4. The device of claim 3, wherein the processor is further configured to access a third plurality of pages arranged in a network such that each page in the third plurality of pages is linked to at least one other page in the third plurality of pages, wherein each page in the third plurality of pages is associated with a respective concept, wherein at least one page of the third plurality of pages is linked to at least one page of the second plurality of pages.

5. The device of claim 4, wherein the processor is further configured to receive comment information via the at least one page of the third plurality of pages and to communicate the comment information via a communications channel to a server.

6. The device of claim 1, wherein each page in the second plurality of pages includes a smaller image of the respective frame of the corresponding page in the first plurality of pages to which the respective page in the second plurality of pages is linked.

7. The device of claim 1, wherein the each page in the first plurality of pages includes a functional button that when selected navigates to the corresponding page in the second plurality of pages.

8. The device of claim 1, wherein the serial adaptation of the body of text comprises a comic version of a work of literature.

9. The device of claim 1, further comprising a touch screen.

10. A method comprising:
displaying a first page of a first plurality of pages, wherein the first plurality of pages are ordered and serially linked, wherein each of the first plurality of pages displays a frame of the serial adaptation of the body of text,
receiving an indication for content associated with a second page of a second plurality of pages, wherein each page in the second plurality of pages corresponds to a respective page in the first plurality of pages, wherein each respective page in the second plurality of pages displays respective first guide information related to the respective frame of the respective page in the first plurality of pages to which the respective page in the second plurality of pages is linked, and
displaying the second page in response to the indication.

11. The method of claim 10, further comprising receiving comment information via the second page and communicating the comment information via a communications channel to a server.

12. The method of claim 10, wherein the first guide information comprises a plurality of concepts.

13. The method of claim 12, further comprising accessing a third plurality of pages arranged in a network such that each page in the third plurality of pages is linked to at least one other page in the third plurality of pages, wherein each page in the third plurality of pages is associated with a respective concept, wherein at least one page of the third plurality of pages is linked to at least one page of the second plurality of pages.

14. The method of claim 13, further comprising receiving comment information via the at least one page of the third plurality of pages and communicating the comment information via a communications channel to a server.

15. The method of claim 10, wherein each page in the second plurality of pages includes a smaller image of the respective frame of the corresponding page in the first plurality of pages to which the respective page in the second plurality of pages is linked.

16. The method of claim 10, wherein the each page in the first plurality of pages includes a functional button that when selected navigates to the corresponding page in the second plurality of pages.

17. The method of claim 10, wherein the serial adaptation of the body of text comprises a comic version of a work of literature.

18. The method of claim 10, further comprising receiving user interaction via a touch screen.

19. A computer readable storage medium having instructions stored thereon that when executed by a processor, perform the following steps, the steps comprising:
displaying a first page of a first plurality of pages, wherein the first plurality of pages are ordered and serially linked, wherein each of the first plurality of pages displays a frame of the serial adaptation of the body of text,
receiving an indication for content associated with a second page of a second plurality of pages, wherein each page in the second plurality of pages corresponds to a respective page in the first plurality of pages, wherein each respective page in the second plurality of pages displays respective first guide information related to the respective frame of the respective page in the first plurality of pages to which the respective page in the second plurality of pages is linked, and
displaying the second page in response to the indication.

20. The computer readable storage medium of claim 19, wherein the computer readable storage medium is a computer readable storage medium for an application store.
